(19) United States
(12) Patent Application Publication
(10) Pub. No.: US 2013/0034771 A1
(43) Pub. Date: Feb. 7, 2013

(54) MULTI-CELL BATTERY

(71) Applicant: Darwin D. Delans, North Wales, PA (US)

(72) Inventor: Darwin D. Delans, North Wales, PA (US)

(73) Assignee: ONEPOINT SOLUTIONS, LLC, Philadelphia, PA (US)

(21) Appl. No.: 13/195,999

(22) Filed: Aug. 2, 2011

(51) Int. Cl. H01M 2/20

(52) U.S. Cl. 429/158

(57) ABSTRACT

A battery with improved power output, reduced heat production and longer performance under constant discharge is disclosed.

### CROSS-REFERENCE TO RELATED APPLICATIONS

This disclosure is related to U.S. patent application Ser. No. 12/926,013 filed Oct. 21, 2010, for a “Battery” in the name of Darwin D. Delans and assigned to OnePoint Solutions, L.L.C. of Philadelphia, Pa. This related application matured out of U.S. Provisional Patent Application Ser. No. 61/279,350 filed on Oct. 21, 2009.

### STATEMENT REGARDING FEDERALLY SPONSORED RESEARCH OR DEVELOPMENT

This invention is not the subject of any federally sponsored research or development.

### STATEMENT REGARDING JOINT RESEARCH AGREEMENTS

The invention discussed in this disclosure was not and is not the result of any joint public or private research agreements.

### BACKGROUND OF THE INVENTION

(1) Field of the Invention

The technical field of the art to which the invention pertains is electrochemical batteries in general and batteries with external cross straps in particular.

(2) Description of the Related Art

Mostly all modern single and multi-cell batteries have posts protruding from the top of the container. Inside each cell, there is a plurality of plates. Posts protruding from opposite sides are disclosed in U.S. Pat. No. 4,983,475 which was issued to this inventor on Jan. 8, 1991. The disclosed battery is illustrated, in part, as a first prior art device in FIGS. 1-4 herein.

In FIG. 1, a positive plate 10 has tabs 12 and 14 protruding from opposite short sides. In FIG. 2, a negative plate 20 has tabs 22 and 24 likewise protruding from opposite short sides. In FIG. 3, a plurality of alternating positive plates 10 and negative plates 20 forms a stack, known as a plate element 30, for insertion into a cell (not shown). In FIG. 4, a plate element 30 is installed in container 40. Container 40 has one post 42 of one polarity protruding from one side thereof. Another post (not shown) of an opposite polarity protrudes from an opposite side of the container 40. The single-cell battery within the container 40 has an internal positive diagonal cross strap 44 on one side of the container 40. An internal negative diagonal cross strap 46 is shown in phantom lines on an opposite side of the container 40. The cross straps 44 and 46 connect the top and the bottom tabs of their respective plate polarities. Taking power off a plurality of the top tabs 12 and the bottom tabs 14, at the same time, reduces internal resistance of the positive plate 10. Taking power off the top tab 22 and the bottom tab 24, at the same time, reduces the internal resistance of the negative plate 20. This arrangement results in more power, i.e. electrical current, being available out of the single-cell battery inside the container 40 when it is compared to a standard single-cell battery of the same weight. However, for a multi-cellular battery, this first prior art device becomes cumbersome. For example, for a 240-cell battery system, the first prior art device requires 240 single-cell batteries with 240 positive cross straps and 240 negative cross straps.

### SUMMARY OF THE INVENTION

This invention is an improvement in multi-cell electrical storage batteries. A battery according to this invention comprises at least two cells, each cell having a first pair of positive and negative terminals, and a second pair of positive and negative terminals. Each of the cells has an electrical connection between the positive terminals of the first pair of terminals on each cell and the negative terminals of the first pair of terminals on another cell, such that the cells are electrically connected in series through the first pairs of positive and negative terminals. There is also an electrical connection between the positive terminals of the second pair of terminals on each cell and the negative terminals of the second pair of terminals on another cell, such that the cells are electrically connected in series through the second pairs of positive and negative terminals. An electrical connection between the negative end of the first terminals connected in series and the negative end of the second terminals connected in series, forms a negative terminal of the multi-cell battery and an electrical connection between of the positive end of the first terminals connected in series and the positive end of the second terminals connected in series, forms a positive terminal of the multi-cell battery.

It will also be appreciated that the cells of the battery may be arrayed in any number of physical arrangements to suit the demands of available space, ease of manufacturing, or manufacturing procedures.

In alternate embodiments, the first pair of terminals and the second pair of terminals on each cell are located on separate locations on the cell, at opposite sides of the cell, or are at separated by a distance of at least one half the length of the cell, or are at separated by a distance of at least one half the length of the cell.

This disclosure describes two embodiments of a battery that reduces the number of cross straps on a battery system utilizing designs similar to U.S. Pat. No. 4,983,475 or any other opposing plate lugged battery design thereby reducing battery system cost and improving system electrical performance.

The first embodiment, FIG. 5, is a single-cell battery that can be electrically connected to a plurality of similar single-cell batteries, thus creating a battery system from which power can be taken from the front and back of all plates simultaneously by using only one pair of external cross straps for the entire system of single-cell batteries. Each single-cell battery has one positive and one negative terminal post protruding from one end of the container and one positive and one negative terminal post protruding from an opposite end of the container. This battery has two major components that make it different from any lead-acid battery on the market today. These components are the container and the method by which these single cell batteries are connected together such that only one pair of cross straps is needed for the entire battery system.

The second embodiment is a multi-cell battery housed in a single container using external positive and negative cross straps mounted on the outside of the container.

Multi-cell batteries constructed according to this invention have very large, and completely unexpected advantages over prior art multi-cell batteries. Among these are increased electrical power output, lower heat production, and longer performance under constant discharge.

The following tests demonstrate these remarkable advantages. Each of these tests compared a multi-cell, lead-acid battery constructed according to the current invention with a prior art battery as a control. The prior art battery was identical to the battery of the invention, except that all of the cells in the control battery were connected in series by way of a single pair of terminals on each cell.

The increased power output of multi-cell batteries of the current invention was demonstrated by a “fan curve test.” This test measures the total power that a battery can produce before its voltage becomes unacceptably low. Three 2 volt cells were connected in series to make a six volt battery. The battery was then discharged to an average cell voltage of 1.67 volts per cell. The time was noted when the average cell voltage reached 1.67 volts per cell. The control battery carried 383 amps for 15 minutes to 1.67 volts per cell. The battery according to this invention carried 483 amps for 15 minutes to an end voltage of 1.67 volts per cell. The battery according to this invention produced 26% more power than an otherwise identical battery.

The improved heat production characteristic of batteries according to the invention is an important and unexpected advantage. Excess heat production is highly undesirable, and can result in the need for expensive cooling, or even battery failure. A control battery and a battery according to this invention (the same as described in the above test) were tested as follows. The control battery was subjected to a 405 amp load, and the battery temperature rose by 38° F. The battery according to this invention was subjected to a 540 amp load, and the battery temperature rose 20° F. Thus, the battery according to this invention carried a 33% greater load, but generated 47% less heat than an otherwise identical battery.

The improved performance of batteries according to this invention under constant discharge conditions is another important advantage. This allows the battery to serve longer before recharging is required. A control battery and a battery according to this invention (the same as described in the above tests) were tested as follows. The two batteries were subjected to a constant load of 2000 watts until the voltage of these 6 volt batteries dropped to 5 volts, the cut-off voltage. The control battery lasted 13.5 minutes. The battery according to this invention lasted 23 minutes, an improvement over the control battery of 70%.

These improvements in performance result in a dramatically more powerful, safer, and more useful multi-cell battery.

### BRIEF DESCRIPTION OF THE DRAWINGS

FIG. 1 shows a front side view of a positive plate of a first prior art battery.

FIG. 2 shows a front side view of a negative plate of the first prior art battery.

FIG. 3 shows a front perspective view of a plate element of the first prior art battery.

FIG. 4 shows a side end view of a container with internal cross straps for the first prior art battery.

FIG. 5. shows an exploded perspective view of a first embodiment of the invention in which a single-cell battery container has opposite end caps.

FIG. 6A shows a left end view of a front end cap on the single-cell battery container in FIG. 5.

FIG. 6B shows a right end view of a back end cap on the single-cell battery container in FIG. 5.

FIG. 7 is a schematic view illustrating how a plurality of the single-cell batteries of the first embodiment may be connected together utilizing only one pair of cross straps for the entire battery.

FIG. 8A is a perspective view of the cross strap assembly of the second embodiment of the invention

FIG. 8B is a cut away view of the positive or negative post that is part of the cross strap assembly.

FIG. 8C is the container 200 of the second embodiment of the invention with no components attached to it.

FIG. 8D is a perspective front end view of a steel jacket protecting the multi-cell battery container of the second embodiment of the invention with the positive and negative cross installed but without the plate elements or end caps in place.

FIG. 8E is a top plan view of the multi-cell battery container without the steel jacket, for the second embodiment of the invention without the end caps in place.

FIG. 8F is a side view of the multi-cell battery container with the steel jacket installed for the second embodiment of the invention with the end caps spaced from the container.

FIG. 9 is a partially broken-away, partially exploded. rear, top, side, perspective view of the container with the multi-cell battery shown for the second embodiment of the invention with one end cap in place.

FIG. 10 is a schematic view illustrating how two single-cell batteries of a second prior art device are connected together.

FIG. 11 is a schematic view illustrating how two single-cell batteries of the first embodiment of the invention may be connected together.

### DETAILED DESCRIPTION OF THE PREFERRED EMBODIMENTS

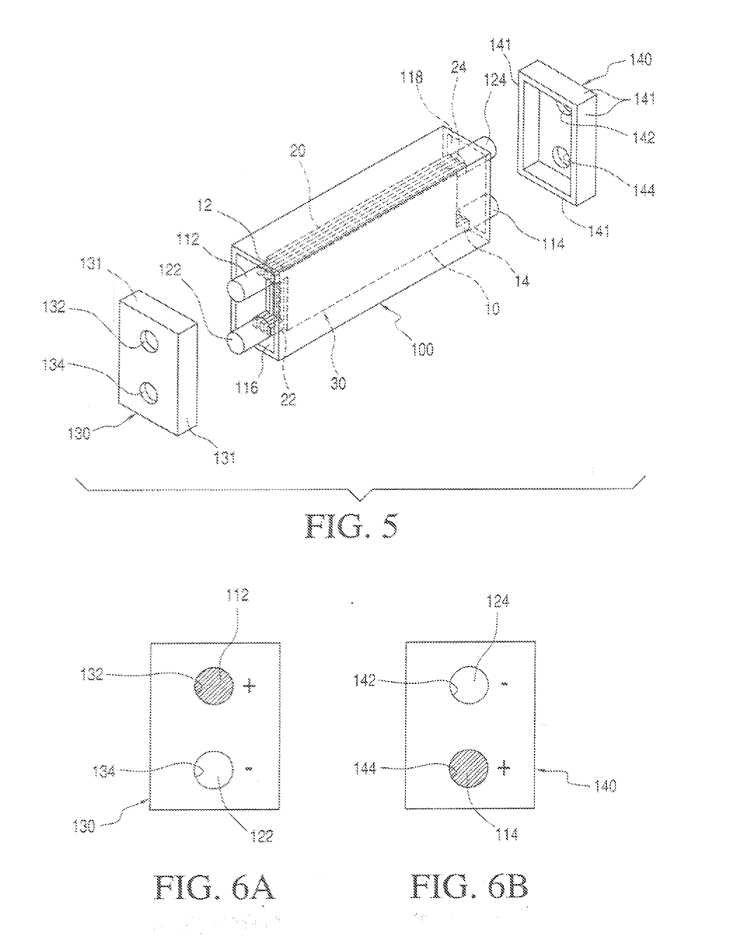

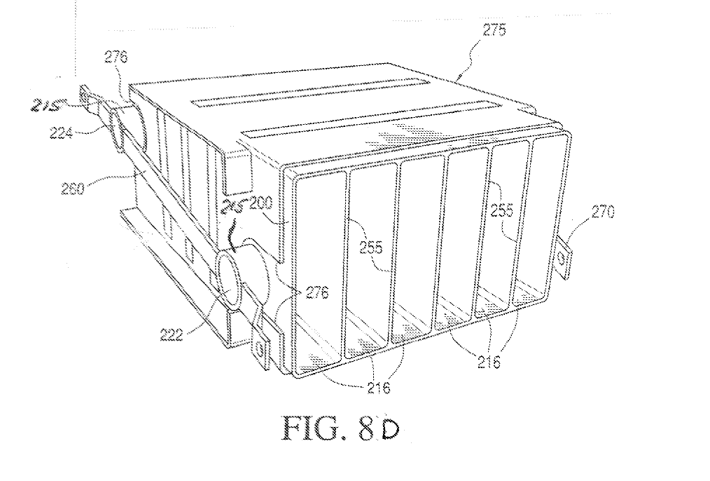

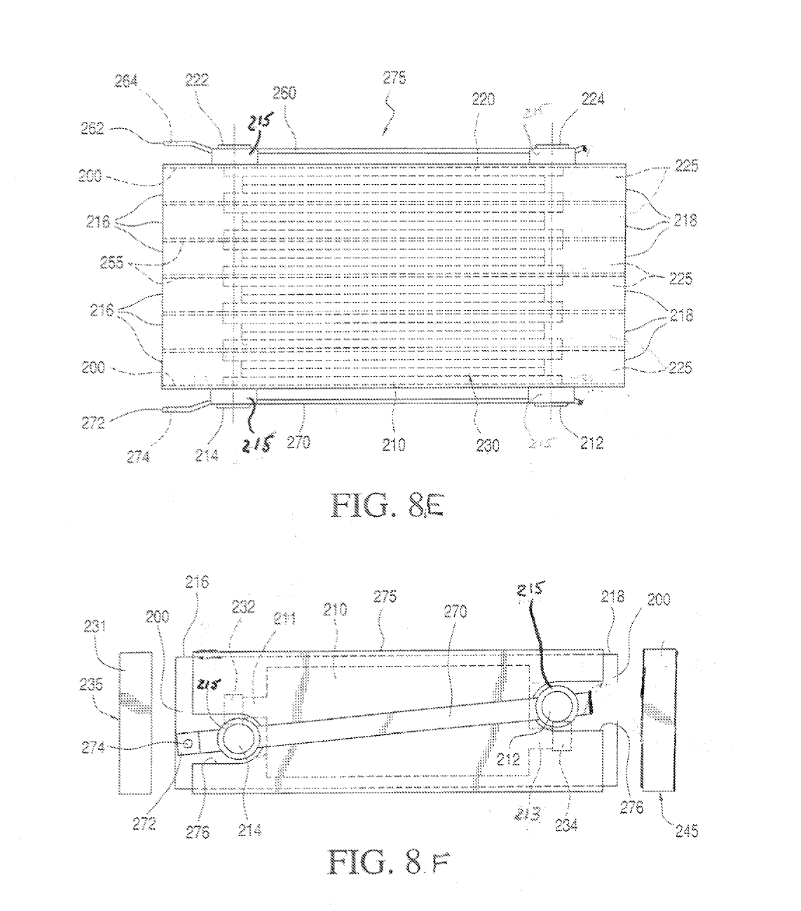

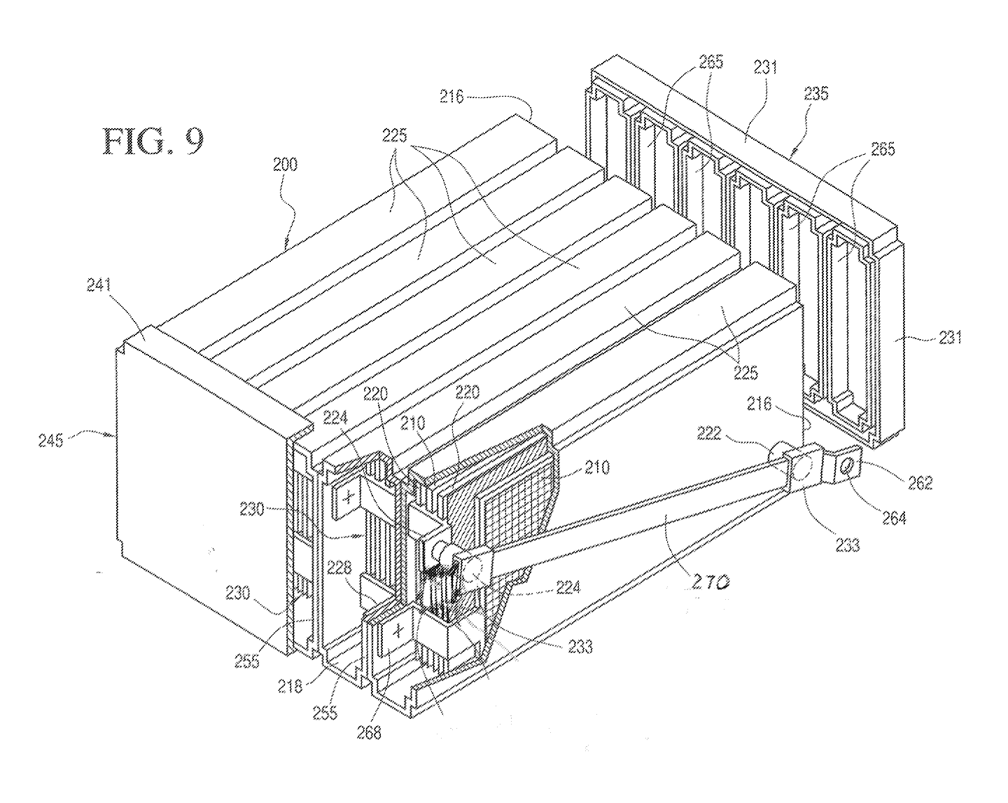

FIGS. 5-7 and 11 show a first preferred embodiment which relates to a single-cell battery while FIGS. 8A-9 show a second preferred embodiment which relates to a multi-cell battery.

In FIG. 5, an exploded perspective view of the first embodiment is shown. A container 100 is a rectangular tube open at two ends and can be formed by an extrusion process. The plate element 30 is loaded inside the container 100 through either of the two open ends and is composed of a plurality of positive plates 10 and a plurality of negative plates 20. Upper positive tabs 12 of the positive plates 10 are connected to an upper positive post 112 through one short open end 116 of the container 100 while lower positive tabs 14 of the positive plate 10 are connected to a lower positive post 114 through an opposite short open end 118 of the container 100. The lower negative tabs 22 of the negative plates 20 are connected to a lower negative post 122 through the one short open end 116 of the container 100 while the upper negative tabs 24 of the negative plates 20 are connected to an upper negative post 124 through the opposite short open end 118 of the container 100. At the open end 116 of the container 100, the upper positive post 112 and the lower negative post 122 are aligned one above the other and protrude through an upper bore 132 and a lower bore 134, respectively, in a front end cap 130. At the opposite open end 118 of the container 100, the upper negative post 124 and the lower positive post 114 are also aligned one above the other and protrude through an upper bore 142 and a lower bore 144, respectively, in a back end cap 140. The front end cap 130 and the back end cap 140 each have four side flanges 131 and 141, respectively, which are heat sealed or glued over the one short open end 116 and the opposite short open end 118, respectively, to sides of the container 100. The four posts 112, 122 and 114, 124 protrude through the front end cap 130 and the back end cap 140, respectively, and then either epoxy sealed to the end caps 140 and 130 or lead burned to the lead inserts (not shown) in bores 132, 134, 142 and 144.

FIG. 6A is a left end view of the upper positive post 112 and the lower negative post 122 protruding through the upper bore 132 and the lower bore 134, respectively, in the front end cap 130.

FIG. 6B is a right end view of the upper negative post 124 and the lower positive post 114 protruding through the upper bore 142 and the lower bore 144, respectively, in the back end cap 140.

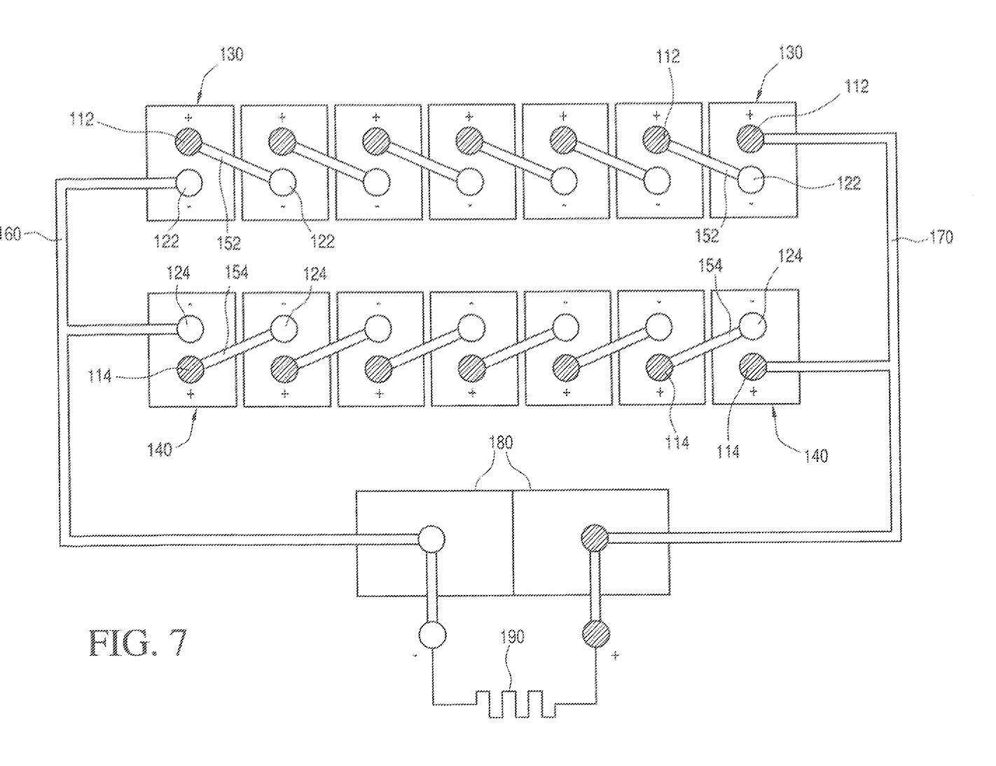

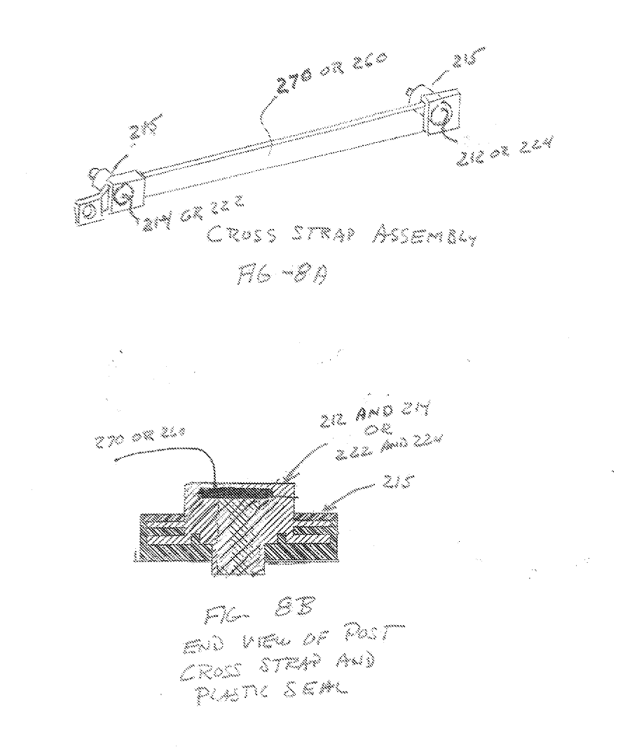

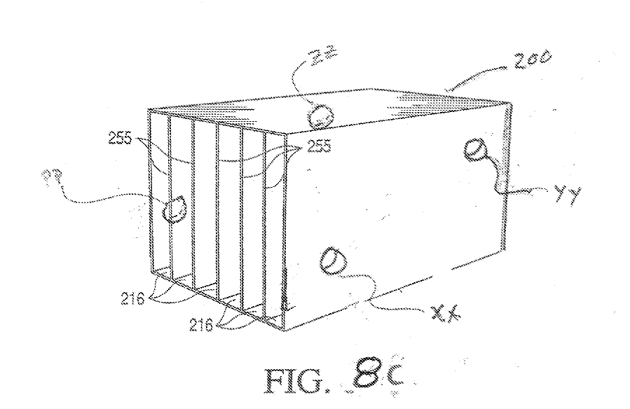

FIG. 7 shows how a plurality of single-cell batteries of the first embodiment may be connected together with one pair of cross straps to draw current effectively from the front end and the back end of all battery plates. As an example, reference is made initially to the upper left most of a plurality of front end caps 130 along a top row (representing the front of the battery) of single-cell batteries. From the front end cap 130, the upper positive post 112 and the lower negative 122 protrude. The upper positive post 112 is connected diagonally by one of a plurality of first cables 152 to the lower negative post 122 of an adjacent single-cell battery. At the same time, the lower negative post 122 of the upper left most of the plurality of front end caps 130, is connected by a negative cross strap 160 to the upper negative post 124 of the back end cap 140. In turn the upper negative post 124 of the back end cap 140 is connected to the external terminal board 180 by connector 500 and in turn, connected to a load 190. This in effect ties together the tops and bottoms of all the negative plates in the entire battery thus reducing the resistance of all the negative plates in the battery system. Now reference is made to the lower left most of a plurality of back end caps 140 of the single-cell batteries. From the back end cap 140, the upper negative post 124 and the lower positive post 114 protrude. The lower positive post 114 is connected diagonally by one of a plurality of second cables 154 to the upper negative post 124 of an adjacent battery. Reference is next made to the upper right most of the plurality of front end caps 130 of single-cell batteries. From the front end cap 130, the upper positive post 112 and the lower negative post 122 protrude. The lower negative post 122 is connected diagonally by another of the plurality of first cables 152 to the upper positive post 112 of another adjacent single-cell battery. At the same time, the upper positive post 112 of the upper right most of the plurality of front end caps 130, is connected by a positive cross strap 170 to the lower positive post 114 of the back end cap 140. In turn the lower positive post 114 of the back end cap 140 is connected to the external terminal board 180 by connector 501 and to a right side of the external terminal board 180 that is, in turn, connected to the load 190. This in effect ties together the tops and bottoms of all the positive plates in the entire battery thus reducing the resistance of all the positive plates in the battery system. Next, reference is made to the lower right most of the plurality of back end caps 140. From the back end cap 140, the upper negative post 124 and the lower positive post 114 protrude. The upper negative post 124 is connected diagonally by another of the plurality of second cables 154 to the lower positive post 114 of another adjacent battery. Connecting the plurality of single-cell batteries in this way will improve cycle life and increase the short rate output current without decreasing the long rate discharge time of each battery. Also, by utilizing the active material more uniformly, the effects of permanent sulfaton of the negative plates is reduced under partial states of discharge. Each single-cell battery will also operate cooler under discharge and fast recharge conditions. For a given output power in either kilowatts or amp hours, this single-cell battery will be smaller and lighter than present day lead-acid batteries. This feature of the invention makes this single-cell battery ideal for utility off-grid storage applications when long rate discharges are desired, partial states of discharge are encountered and yet runs cooler under high rates of discharge and when accepting high rates, i.e. fast, recharge current. The single-cell battery of this first embodiment of the invention is also useful for Uninterruptable Power Supply (UPS) and utility switch gear & control applications when short rate discharges are required.

FIG. 8A is a perspective view of the positive or negative cross strap assembly 270 or 260 of the second embodiment of the invention.

FIG. 8B is a cross section view of the positive post 212 and 214 or negative posts 222 and 224 and plastic seals 215 with the positive or negative cross strap 270 or 260 imbedded in the positive posts 212 and 214 or negative posts 222 and 224.

FIG. 8C is a perspective front view of a multi-cell container 200 with nothing installed. Holes YY and XX provide electrical access for the positive cross strap assembly 270 of FIG. 8A to positive plates 210. Holes PP and ZZ provide electrical access for the negative cross strap assembly 260 of FIG. 8A to negative plates 220. After the container 200 is installed into the steel jacket 275 of FIG. 8D the positive and negative cross strap assemblies 270 and 260 FIG. 8A are positioned in steel jack cut outs 276 over holes XX, YY, ZZ and PP, and then the plastic seals are heat sealed to the container 200.

FIG. 8E is a top plan view of the six battery cells inside the container 200, without the steel jacket for the second embodiment of the invention. One plate element 230 has been loaded into each of six cells 225 through either one of the short open ends 216 or opposite short open ends 218. The positive cross strap 270 connects through the posts 212 and 214 which are spot welded to a front and a back of positive plates 210 on an outermost cell of the cells 225. The negative cross strap 260 connects through the posts 222 and 224 which are spot welded to a front and a back of negative plates 220 on the opposite outermost cell of the cells 225. Of the four internal cells 225, the positive and negative plate tabs (not show) of adjacent cells are connected together by standard manufacturing techniques. The partitions 255, separating adjacent cells 225, extend the entire length of the container 200. The flared end 262 of the negative cross strap 260 has a bore 264 and the flared end 272 of the positive cross strap 270 has a bore 274.

FIG. 8F is a side view of the steel jacket 275 with the six-cell battery inside the container 200 for the second embodiment of the invention. The cut out portions 276 in the steel jacket 275 allow the posts 214 and 212 to protrude from the container 200, through the steel jacket 275. Inside the container 200, there is shown in phantom lines the outermost positive plate 210 with its upper tab 211 and its lower tab 213. The positive post 214 extends through hole XX (FIG. 8A) on one end of the container 200 and is connected by a spot weld to the plurality of posts 232 which are connected to the plurality of upper positive tabs 211. Likewise, the positive post 212 extends through hole YY (FIG. 8A) at the opposite end of the container 200 and is connected by a spot weld to the plurality of posts 234 which are connected to the plurality of lower positive tabs 213. Although not shown a similar procedure is performed on the opposite side of container 200 for the negative cross strap 260 assembly to the container 200 A front end cover 235 and a back end cover 245 each have their side flanges 231 and 241, respectively, heat-sealed or glued over the short open end 216 and the opposite short open end 218, respectively, to sides of the container 200.

Returning to FIG. 8E, one may see that the flared ends 262 and 272 of the negative cross strap 260 and the positive cross strap 270, respectively, accommodate opposite side flanges 231 of the front end cover 235 of FIG. 8F. At the left side of FIG. 8F, the flared end 272 of the positive cross strap 270 has the bore 274 there through for accommodating a bolt or other fastener (not shown) which is used to electrically connect, through bore 264 of flared end 262 of the adjacent battery negative cross strap 260. Unlike standard lead acid batteries it is possible to connect directly from one battery post to the post of the adjacent battery without using separate connecting hardware.

FIG. 9 is a partially broken away, partially exploded, rear, top, side, perspective view of the container 200 with six cells 225 of the battery for the second embodiment of the invention. The back end cover 245 has its side flanges 241 heat sealed over the short open end 218 of the container 200 while the front end cover 235 with its side flanges 231 is spaced away from the other short open end 216. The front end cover 235, as well as the hack end cover 245 has ribs 265 which line up with the partitions 255 separating each cell 225. Inside each cell 225, there is a plate element 230 made up of alternating positive plates 210 and negative plates 220. The negative cross strap 260 has flared end 262 with bore 264 there through, which accommodates a bolt or other fastener (not shown) to electrically connect to the opposite polarity cross strap of the adjacent battery. Unlike standard lead acid batteries it is possible to connect directly from one battery post to the post of the adjacent battery without using separate connecting hardware.

As seen in the lower left, partially broken away corner of the container 200, the upper negative post 224 contacts all upper negative tabs 228 on the negative plates 220. A positive inter-cell connection plate 268 of the outside cell 225 is connected through the partition 255 to a negative inter-cell connection plate 228 of the adjacent cell 225.

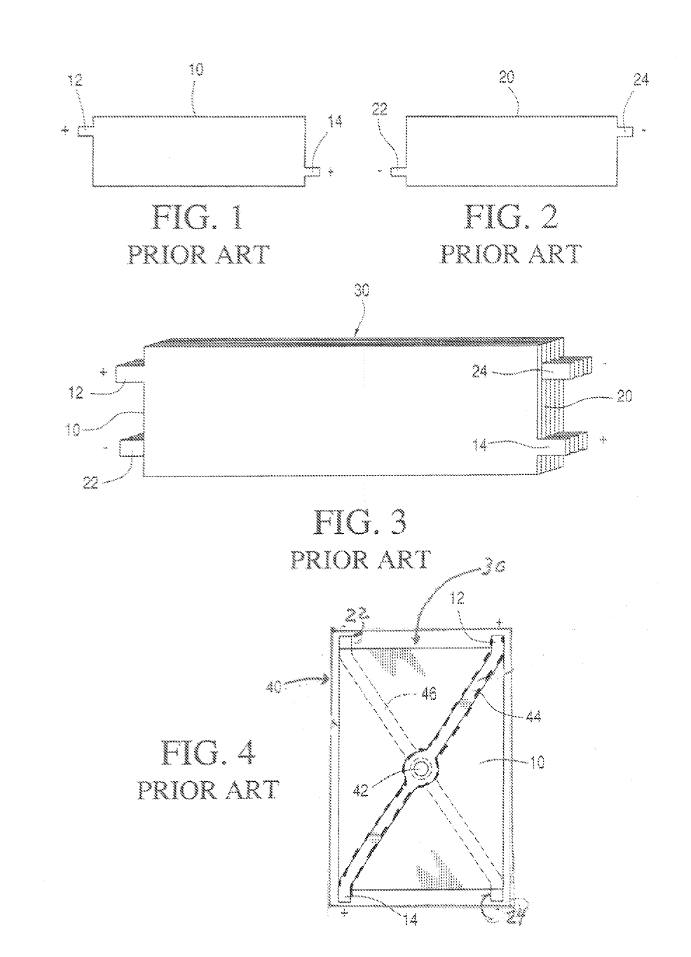

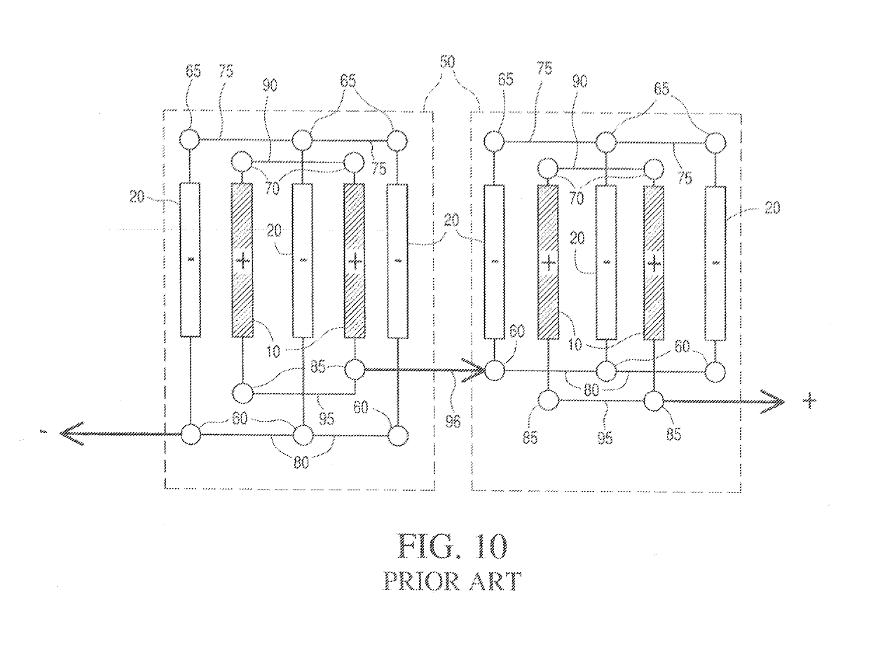

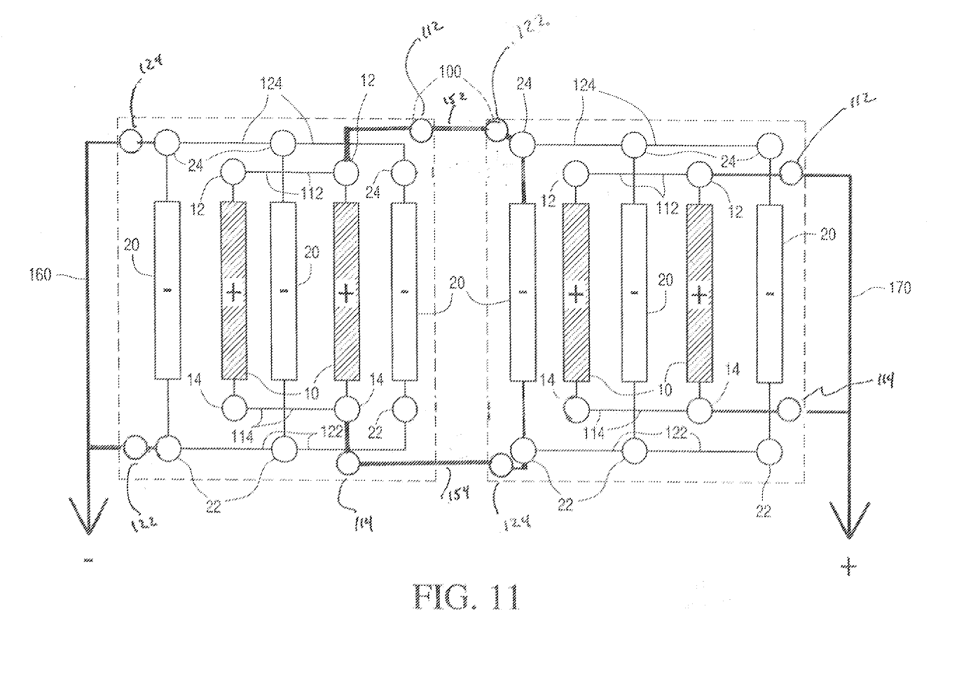

FIG. 10 shows a plate configuration which is the subject of U.S. Pat. No. 6,531,247 issued to Yang on Mar. 11, 2003. In this second prior art device, there are two containers 50, each with a battery cell inside. Each cell has a plate element which is a plurality of alternating positive plates and negative plates 20. Tabs, shown as rectangles in FIGS. 1-4, are shown as circles in FIGS. 10 and 11. Yang connects bottom tabs 60 of the negative plates 20 together with a first bar 80 in each container 50. Yang also connects top tabs 70 of the positive plates 10 together with a second bar 90 in each container 50. Top tabs 65 of the negative plates 20 are connected together with a third bar 75 while bottom tabs 85 of the positive plates 10 are connected together with a fourth bar 95. When Yang connects the cell in the one container 50 to the cell in the adjacent container 50, he uses a single conductor 96 extending between the bottom tab 85 of one positive plate 10 in the left cell to the bottom tab 60 of one negative plate 20 in the right adjacent cell. The positive plates 10 and the negative plates 20 are parallel in each container 50. Then, the left container 50 is connected in series with the one conductor 96 to the right container 50. In effect, the battery system of Yang will have more resistance than the present invention because Yang does not use a cross strap at all.

FIG. 11 is a schematic view showing how two single-cell batteries of the first embodiment in FIG. 5 are connected together. In FIG. 11, there are shown two of the containers 100, each with a battery cell inside. Each cell has a plate element which is a plurality of alternating positive plates 10 and negative plates 20. The bottom tabs 22 of the negative plates 20 are connected together by the post 122, in each container 100. The top tabs 12 of the positive plates 10 are connected together by the post 112, in each container 100. The top tabs 24 of the negative plates 20 are connected together by the post 124, in each container 100. The bottom tabs 14 of the positive plates 10 are connected together by the post 114, in each container 100. When the cell in one container 100 is connected to the cell in the adjacent container 100, a first conductor 154 extends from the bottom positive post 114 of the left most positive plate 10 in the left container 100 to the top most negative post 124 of the negative plate 20 in the right container 100. Also, a second conductor 152 extends from the top positive post 112 of the same left most positive plate 10 in the left container 100 to the bottom negative post 122 of the same negative plate 20 in the right container 100. Thus, all of the positive plates 10 and the negative plates 20 in the entire battery system of the present invention are connected in parallel. The negative cross strap 160 of FIG. 7 is shown in FIG. 11 to be connected between the top negative post 124 and the bottom negative post 122 of the left most negative plate 20 in the left container 100 while the positive cross strap 170 of FIG. 7 is shown in FIG. 11 to be connected between the top positive post 112 and the bottom positive post 114 of the positive plate 10 in the right container 100.

Many industries need and use stored energy to provide backup electrical power in the event of a power interruption to critical machines, such as those functioning in hospitals, telephone companies, banks and vital manufacturing plants. Mission critical computers have Uninterruptable Power Supplies (UPS) to ensure continuing operation or to provide power long enough to be able to have an orderly shutdown in case of the loss of power due to a utility failure. Lead-acid batteries provide this stored energy.

Utility companies today are under great pressure to reduce the cost of producing electrical energy. Federal law requires that the utilities have a certain amount of excess capacity, called spinning reserve, to cover peak demand requirements. The utilities are also looking at various ways to reduce their dependency on fossil-fuel backup generators for emergency grid overload situations. The utilities also must meet the National Energy Regulatory Commission (NERC) requirements for system frequency. The utilities are moving toward off-grid battery storage as one component of the proposed Smart Grid systems, to take advantage of off-peak capacity to charge large banks of batteries and to use the energy stored therein to supply electrical power during periods of peak demand, a practice known as peak shaving, thereby improving the overall system efficiency. This practice reduces operating costs and also defers expensive system upgrades.

The utilities have installed several large, lead-acid battery energy storage (BES) systems for this purpose and technically they have been successful. However, economically, they have not lived up to their anticipated life expectancy and have required more maintenance than predicted. Moreover, the duty cycle imposed on present lead-acid battery systems is greater so that their life expectancies are reduced. Procedures, such as deep cycle discharges, result in shedding of active plate material. Operating in a partial state of discharge results in life-shortening plate sulfation. Internal heat generated during charging and discharging accelerates corrosion. All of these procedures reduce battery life. In addition, flooded batteries requires expensive air handling systems, wash stations for eye irritation, acid spill containment, and generally more maintenance than sealed, valve-regulated, lead-acid (VRLA) batteries.

The two embodiments of the battery proposed in this disclosure are intended to be VRLA batteries using absorbed glass mat (AGM) technology. VRLA AGM batteries, with their reduced maintenance, when coupled with the features of these two embodiments, will solve the life-shortening causes described above, as well as the excessive maintenance problems, not only for the utility industry but also for the UPS market.

The double-ended structure of both embodiments spreads out the utilization of the active plate material for a given discharge. This spreading out results in a shallower depth of conversion, i.e. discharge of the active material, thus minimizing the shedding of such material from the plates. The shallower conversion also creates smaller sulfate crystals, thereby making it easier to convert the crystals back into active plate material. The battery load and the charging current are split with half going in or out the front of the battery plate and the other half going in or out the back of the battery plate. Since plate resistance heating is a function of the square of the current, the heat generated by the load and the charging current is less by a factor of four. Thus, these two new battery embodiments will operate longer under cycling conditions and also under a partial state of discharge. Furthermore, less life-shortening heat will be generated during charging and recharging conditions than in a standard lead-acid battery.

Using one pair of cross straps for a battery system with multiple single-cell battery containers or using one pair of cross straps for every multi-cell battery container, such as but not limited to the six-cell battery shown in FIGS. 8A-9, reduces manufacturing costs and saves valuable customer floor space, when compared to the first prior art device shown in FIGS. 1-4. The two battery embodiments of this invention have a positive post and a negative post protruding from each end of the container, whereas the first prior art device of FIGS. 1-4 has only one post protruding from each end of the battery container plus a pair of cross strap for each battery cell

From the foregoing detailed description of the two preferred embodiments, it should be apparent to those skilled in the art of manufacturing batteries that other constructions and modifications may be made and will still be considered within the scope of the invention.

Therefore, it should be understood that I do not intend to be limited to the two embodiments specifically described above, but it is my intention to be bound only by the scope of the appended claims.

1. A multi-cell electrical storage battery, comprising:
a) At least two cells, each cell having a first pair of positive and negative terminals, and a second pair of positive and negative terminals,
b) An electrical connection between the positive terminals of the first pair of terminals on each cell and the negative terminals of the first pair of terminals on another cell, such that the cells are electrically connected in series through the first pairs of positive and negative terminals,
c) An electrical connection between the positive terminals of the second pair of terminals on each cell and the negative terminals of the second pair of terminals on another cell, such that the cells are electrically connected in series through the second pairs of positive and negative terminals,
d) An electrical connection between the negative end of the first terminals connected in series and the negative end of the second terminals connected in series, forming a negative terminal of the multi-cell battery,
e) An electrical connection between of the positive end of the first terminals connected in series and the positive end of the second terminals connected in series, forming a positive terminal of the multi-cell battery.

2. The battery of claim 1, wherein the first pair of terminals and the second pair of terminals on each cell are located at opposite sides of the cell.

3. The battery of claim 1, wherein the first pair of terminals and the second pair of terminals on each cell are at separate locations on the cell.

4. The battery of claim 1, wherein the first pair of terminals and the second pair of terminals on each cell are at separated by a distance of at least one half the length of the cell
